(19) United States
(12) Patent Application Publication
(10) Pub. No.: US 2012/0240373 A1
(43) Pub. Date: Sep. 27, 2012

(54) METHOD OF IN SITU REPAIR OF A WELLHEAD BASE FLANGE

(75) Inventor: Denis DEVILLEGER, Marcq (FR)

(73) Assignee: STORENGY, Bois Colombes (FR)

(21) Appl. No.: 13/420,667

(22) Filed: Mar. 15, 2012

(30) Foreign Application Priority Data
Mar. 25, 2011 (FR) 11 52 482

(51) Int. Cl. B23P 6/00; B23P 19/00

(52) U.S. Cl. 29/402.01; 29/700

(57) ABSTRACT

An in situ method for repairing a base flange of a wellhead. At least one layer of a polymerizable composite material is applied to a damaged surface, an elastic seal is placed on the layer of composite material, and a reinforcing collar is pressed against the seal on the surface of the flange covered with the composite material. An arrangement of an in situ repair of a base flange of a wellhead includes at least one layer of a polymerized composite material on a damaged surface, an elastic seal on the composite material, and a reinforcing collar pressing the seal against the damaged surface.

### FIELD OF THE INVENTION

The present invention relates to an in situ repair method for a base flange of a wellhead as well as an arrangement for the in situ repair of such a flange.

### BACKGROUND

The base flange of a wellhead is the element that makes it possible to provide the junction and ensure sealing between a tubing that comes from the bottom of the well and a surface facility from which connecting pipes convey what is produced by the well, for example oil, gas or water, to a distribution grid.

The base flange, which is installed during construction of the well, may undergo deteriorations over time, in particular due to corrosion, resulting from leaks. When the base flange must be restored, it is necessary to stop the well, purge it, and disassemble the wellhead to be able to restore the base flange and adjacent elements, in particular the tube on which the wellhead is mounted, or, if applicable, install new pieces.

Stopping a well being expensive, it is only possible in exceptional cases. Thus, the repair of a base flange of a wellhead is considered impossible.

### SUMMARY OF THE INVENTION

The aim of the invention is to propose a solution to this problem.

The aim of the invention is achieved with an in situ repair method for a base flange of a wellhead, comprising at least the following steps:

applying at least one layer of a polymerizable composite material on the damaged and then pickled surfaces of the base flange and an adjacent piece with which the base flange is in contact, generally the tube on which the wellhead is mounted,

placing an elastic seal on the layer of composite material, when the latter is polymerized, at the junction between the base flange and the adjacent piece,

placing a reinforcing collar adapted to press the seal on the surface covered with the composite material of the flange.

According to different possible embodiments, the method according to the invention can also comprise at least one of the following steps:

before application of a layer of polymerizable composite material on the damaged surface of the base flange and the adjacent piece:

pickling the damaged surface,

applying a layer of an anti-corrosion product on the pickled surface;

after the application of a layer of polymerizable composite material on the damaged surface and before placement of the elastic seal:

applying several layers of the composite material to prepare a bed for the elastic seal;

after placement of the elastic seal and before placement of the reinforcing collar:

applying at least one layer of composite material on either side of the seal;

when the base flange is placed on a tubing comprising a double wall below the flange, the space between the two walls for example being filled with cement:

placing an annular foam bead on the filling of the space between the two tubes and

pouring an epoxy resin crown on the bead so that it has an upper surface sloped toward the outside of the tubing in order to avoid water stagnation and corrosion.

The aim of the invention is also achieved with an arrangement for the in situ repair of a base flange of a wellhead, which comprises at least one layer of a polymerized composite material applied on the damaged and previously pickled surfaces of the base flange and an adjacent piece such as the tube on which the wellhead is mounted, respectively, an elastic seal intended to be placed on the composite material previously applied when the latter is polymerized, at the junction between the base flange and the adjacent piece, and a reinforcing collar configured to press the seal on the damaged surface.

This arrangement can also comprise, when the base flange is placed on a tubing comprising a double wall below the flange, the space between the two walls for example being filled with cement,

an annular foam bead on the cement filling and

an epoxy resin crown poured on the bead so that it has an upper surface sloping toward the outside of the tubing.

Other features and advantages of the present invention will appear from the description below of one embodiment of the method according to the invention.

### BRIEF DESCRIPTION OF DRAWINGS FIGURES

The description is done in reference to the appended drawings, in which

FIG. 1 is a diagrammatic perspective view of the bottom portion of a wellhead,

FIG. 2 is a cross-sectional view of the junction between a wellhead and the tubing of the well, and

FIG. 3 is a cross-sectional view of the position of the base flange relative to the back of the cave of the connector.

### DETAILED DESCRIPTION

According to the repair method covered by the present invention, the repair of the base flange of a well is done in situ, i.e. without disassembling the wellhead. The well therefore remains operational.

The damage to be repaired generally being situated below the base flange, more particularly at the junction between the base flange and the tubing on which the wellhead is engaged, the repair consists of removing the traces of corrosion, protecting the cleaned surface with a suitable coating, and applying a polymer resin or any other polymerizable composite material suitable to protect the flange from being accessed by corrosive vapors or liquids.

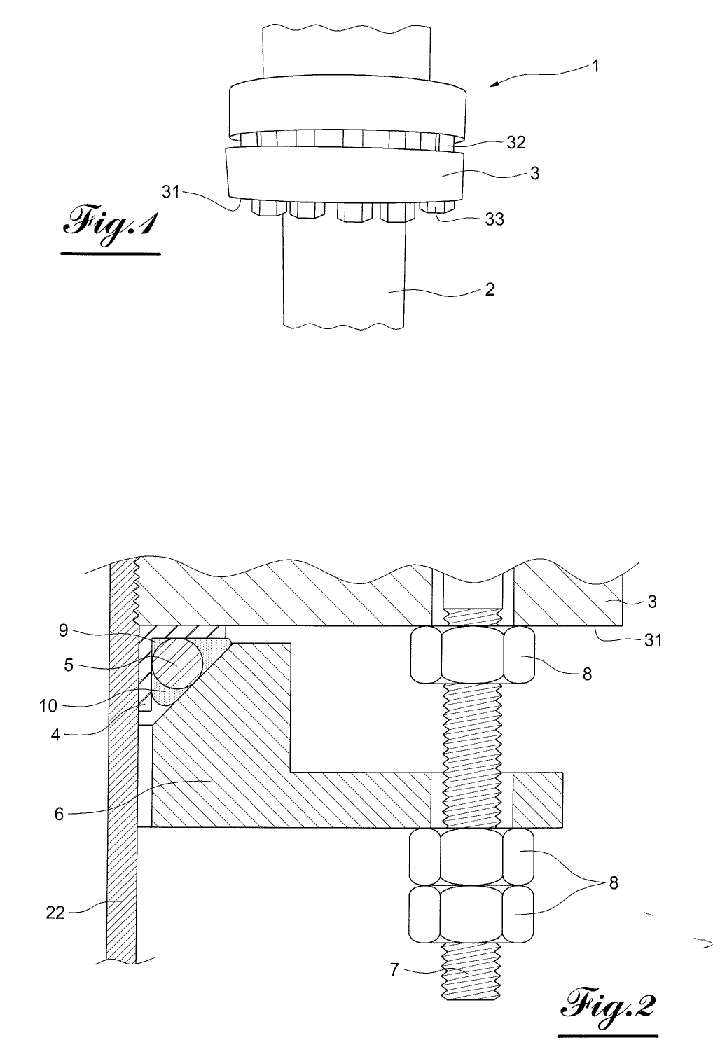

The design of a well to which the repair method according to the invention applies is visible in FIG. 1. A wellhead 1 is fixed on a production pipe or tubing 2 coming from the bottom of the well through a base flange 3. The flange 3 comprises a lower surface 31 on which the heads 33 of screws 32 by which the flange 3 is fixed to the wellhead 1 bear upon tightening. The lower surface 31 can be at a right angle, as in the appended drawings, but also at obtuse angles of up to about 160°.

As shown in FIG. 3, a gas well can be provided with a triple tubing 2 comprising a gas production tube 21, an intermediate tube 22 on which the base flange 3 is screwed, and an outer tube 23. This triple tubing 2 constitutes two security annuluses 24, 25 to prevent the escape of gas and pollution from the environment.

The first annulus 24 is situated between the production tube 21 and the intermediate tube 22. This annulus is filled with water and must not be pressurized. If, on the contrary, this annulus is pressurized, this indicates a leak at one of the elements at the bottom of the well.

The second annulus 25 is situated between the intermediate tube 22 and the outer tube 23 and is filled with cement.

If, over time, a leak arises at the bottom of the well, the gas rises to the surface through the first annulus 24 and reaches the base flange 3 level. The junction threading between the intermediate tube 22 and the base flange 3 not necessarily being sealed, the leak arises at the surface in the cave. More particularly, corrosion occurs on the lower surface 31 of the flange 3, but also on the outer wall of the intermediate tube 22, close to the junction between the flange 3 and the tube 22. The invention proposes to seal this leak by applying one or more polymer layers 4 framing an O-ring 5, the whole being compressed by a metal reinforcing collar 6 forced by studs 7 that replace the screws 32 by which the base flange 3 is initially secured with the wellhead 1.

At the very beginning of the repair, the corroded surfaces of the flange 3 and the tube 22 are pickled and carefully cleaned, in particular degreased, so as to then be able to apply a composite polymer repair material, in particular an elastomer, to two components. The pickling is advantageously done by sandblasting or grit blasting with particles fine enough to obtain a roughness in the vicinity of 75 micrometers of the surface of the tube 22 and the surface 31 of the flange 3.

Then, the pickled surfaces are treated with an anti-corrosion coating to prevent any new corrosion until a composite protective material is applied.

Afterward, the composite repair material, which is advantageously an elastomer polymer material with two components, is applied on the surfaces to be treated in one or more layers 4 according to the indications by the material's manufacturer, in particular relative to the polymerization duration and temperature determined by the manufacturer. The first of the three mandatory steps of the inventive method is characteristic of the method according to the invention, the pickling and anti-corrosion steps being able to be modified depending on the specific nature and extent of the particular damage to be repaired.

In the following step, the site provided for the O-ring 5 is prepared by filling a zone 9 situated between the screw pitch of the tube 22 and the site of the O-ring with several layers of polymer repair composite materials, according to the stipulations by the manufacturer of the composite material.

Then, the O-ring 5, which is for example made from nitrile, is placed in the angle formed by the lower surface 31 of the base flange 3 and the outer surface of the tube 22.

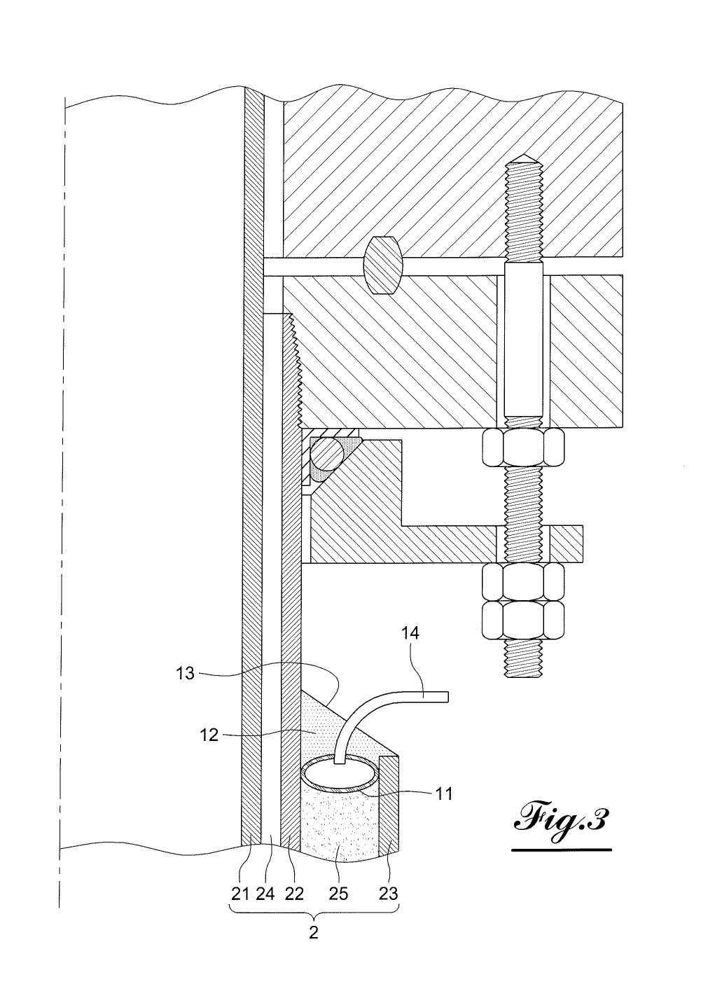

When the O-ring 5 is in place, the place present on either side of the O-ring is filled with at least one, generally several layers 10 of composite elastomer polymer repair materials. Lastly, to keep the O-ring 5 in place and press it against the layers 4 of composite materials, the reinforcing collar 6, which itself is protected from corrosion by a coating, is positioned below the base flange 3. The reinforcing collar 6, which is designed in two half-shells to be able to place it around the flange 3, is kept on the studs 7 using nuts 8 whereof the first nut secures the corresponding stud 7 in the base flange 3 and whereof two other nuts, used as nut/locknut, secure the collar 6 on the corresponding stud 7 as shown in FIGS. 2 and 3.

Subsequently, as shown in FIG. 3, if over time a leak is observed in the second annulus 25, a sealing device is made with an annular bead 11 made from polyurethane foam and a cast crown 12 made from epoxy resin so that, when the resin is set, it has an upper surface 13 sloping toward the outside of the tube 23 so as to prevent water stagnation and corrosion. A small tube 14 is mounted in the bead 11 so as to capture the gas to monitor whether there is a pressure increase or to analyze the gas or determine the leakage rate. A valve and a pressure gauge are mounted on the free end of the small tube 14.

1. A method of in situ repair of a base flange of a wellhead comprising:
applying at least one layer of a polymerizable composite material to a damaged surface of the base flange and an adjacent piece,
placing an elastic seal on the layer of composite material, after the polymerizable composite material has polymerized, at a junction between the base flange and the adjacent piece, and
placing a reinforcing collar to press the elastic seal against a surface of the base flange covered with the composite material.

2. The method according to claim 1, further comprising:
before application of the layer of the polymerizable composite material to the damaged surface of the base flange, pickling the damaged surface, and
applying a layer of an anti-corrosion product to the damaged surface that has been pickled.

3. The method according to claim 2, further comprising, applying the layer of the polymerizable composite material to the damaged surface, and, before placing the elastic seal, applying multiple layers of the polymerizable composite material to prepare a bed for the elastic seal.

4. The method according to claim 3, further comprising, after placing the elastic seal and before placing the reinforcing collar, applying at least one layer of the polymerizable composite material on both sides of the elastic seal.

5. The method according to claim 1, wherein the base flange is located on triple tubing comprising an intermediate tube and an outer tube below the flange, the method comprising:
filling space between the intermediate and outer tubes:
placing an annular foam bead on the material filling the space between the intermediate and outer tubes, and
pouring an epoxy resin crown on the annular foam bead to form an upper surface sloped toward an outside surface of the triple tubing to avoid water stagnation and corrosion.

6. An arrangement producing an in situ repair of a base flange of a wellhead, comprising:
at least one layer of a polymerized composite material on a damaged and previously pickled surface of the base flange,
an elastic seal on the composite material, and
a reinforcing collar pressing the elastic seal against the damaged and previously pickled surface.

7. The arrangement according to claim 6, including:
triple tubing comprising an intermediate tube and an outer tube below and on which the base flange is located,
a material filling space between the intermediate and outer tubes, and
an epoxy resin crown with an upper surface sloping toward the triple tubing on the material filling the space between walls of the intermediate and outer tubes.

8. A well repaired using the method according to claim 1.

9. A well comprising an arrangement according to claim 6.
